(19) United States
(12) Patent Application Publication
(10) Pub. No.: US 2022/0371909 A1
(43) Pub. Date: Nov. 24, 2022

(54) ZIRCONIA AEROGELS AS SUBSTRATES FOR THE SORPTION AND DECOMPOSITION OF TOXIC ORGANOPHOSPHOROUS AGENTS

(71) Applicant: The Government of the United States of America, as represented by the Secretary of the Navy, Arlington, VA (US)

(72) Inventors: Jeffrey W. Long, Alexandria, VA (US); Christopher N. Chervin, Washington, DC (US); Robert B. Balow, Mount Ranier, MD (US); Jeffrey C. Owrutsky, Silver Spring, MD (US); Debra R. Rolison, Arlington, VA (US); Kenan O. Fears, Alexandria, VA (US)

(73) Assignee: The Government of the United States of America, as represented by the Secretary of the Navy, Arlington, VA (US)

(21) Appl. No.: 17/817,485

(22) Filed: Aug. 4, 2022

Related U.S. Application Data
(63) Continuation of application No. 16/953,564, filed on Nov. 20, 2020, now abandoned.
(60) Provisional application No. 63/007,519, filed on Apr. 9, 2020.

(51) Int. Cl. C01G 25/02; C01G 25/00

(52) U.S. Cl. CPC C01G 25/02; C01G 25/003; C01P 2006/80

(57) ABSTRACT

Disclosed is a method of decontamination by exposing a zirconium oxy(hydroxide) aerogel to a liquid, vapor, or gaseous sample suspected of containing a phosphonate compound. The aerogel may be doped with Fe³⁺ ions, Ce³⁺ ions, or SO₄²⁻ ions. The aerogel may be made by: providing a solution of ZrCl₄; FeCl₃, CeCl₃, or Zr(SO₄)₂; and a solvent; adding a cyclic ether to the solution to form a gel; infiltrating the gel with liquid carbon dioxide; applying a temperature and pressure to form supercritical fluid carbon dioxide; and removing the carbon dioxide for form an aerogel.

This application is a continuation application of U.S. patent application Ser. No. 16/953,564, filed on Nov. 20, 2020, which claims the benefit of U.S. Provisional Application No. 63/007,519, filed on Apr. 9, 2020. The provisional application and all other publications and patent documents referred to throughout this nonprovisional application are incorporated herein by reference.

### TECHNICAL FIELD

The present disclosure is generally related to zirconia aerogels for decontamination.

### DESCRIPTION OF RELATED ART

The ability to mitigate chemical warfare agents (CWAs) and toxic industrial compounds (TICs) under realistic environmental conditions remains a critical challenge worldwide (Smith, Catalytic Methods for the Destruction of Chemical Warfare Agents under Ambient Conditions. Chem. Soc. Rev. 2008, 37, 470-478; Kim et al. Chem. Rev. 2011, 111, 5345-5403). Specific types of nanostructured metal oxides and hydroxides effectively abate such hazardous chemicals (Štengl et al. Nanostructured Metal Oxides for Stoichiometric Degradation of Chemical Warfare Agents. In Reviews of Environmental Contamination and Toxicology; Springer Publishing, New York, 2016, 236, 239-258) because their high density of surface hydroxyl groups promote hydrolysis-based decomposition of compounds of interest, including organophosphorus CWAs. Among such solid reactants, zirconium hydroxide (Zr(OH)₄) is arguably the most successful to date, showing activity against a wide range of CWAs and TICs (Bandosz et al. Reactions of VX, GD, and HD with Zr(OH)₄: Near Instantaneous Decontamination of VX. J. Phys. Chem. C 2012, 116, 11606-11614; Peterson et al. Zirconium Hydroxide as a Reactive Substrate for the Removal of Sulfur Dioxide. Ind. Eng. Chem. Res. 2009, 48, 1694-1698).

Zirconium hydroxide is intrinsically amorphous and has many diverse and reactive surface species, such as free hydroxyls and coordinatively unsaturated Zr⁴⁺/Zr³⁺ and O²⁻ sites, that confer broad-spectrum decontamination properties (Schweigert et al. Hydrolysis of Dimethyl Methylphosphonate by the Cyclic Tetramer of Zirconium Hydroxide. J. Phys. Chem. A 2017, 121, 7690-7696; Iordanov et al. Computational Modeling of the Structure and Properties of Zr(OH)₄. J. Phys. Chem. C 2018, 122, 5385-5400). Additionally, Zr(OH)₄ has demonstrated some of the fastest reported decomposition times for V- and G-type CWAs (Bandosz). Recent work has also shown that Zr(OH)₄ is stable in air and remains reactive after exposure to common atmospheric species such as H₂O and CO₂ (Balow et al. Environmental Effects on Zirconium Hydroxide Nanoparticles and Chemical Warfare Agent Decomposition: Implications of Atmospheric Water and Carbon Dioxide. ACS Appl. Mater. Interfaces 2017, 9, 39747-39757). As a result, Zr(OH)₄ is presently being developed and deployed for CWA mitigation (https://techlinkcenter.org/us-army-formulates-new-fast-acting-spray-for-chemical-weapons-decontamination/). One drawback of Zr(OH)₄ is that it suffers from low thermal stability due to the condensation of surface hydroxyl species at treatment temperatures >250° C., ultimately forming unreactive ZrO2 (King et al. Local Structure of Zr(OH)₄ and the Effect of Calcination Temperature from X-Ray Pair Distribution Function Analysis. Inorg. Chem. 2018, 57, 2797-2803). The hydroxyl-based reactivity of Zr(OH)₄ has inspired the development of other nanostructured materials that contain Zr—OH functionality, including mesoporous zirconium oxyhydroxides (Colon-Ortiz et al. Disordered Mesoporous Zirconium (Hydr)oxides for Decomposition of Dimethyl Chlorophosphate. ACS Appl. Mater. Interfaces 2019, 11, 17931-17939), electrodeposited zirconium hydroxide (Jeon et al. ACS Appl. Nano Mater. 2019, 2, 2295-2307), and Zr-containing metal-organic framework (MOF) compounds (Moon et al. Instantaneous Hydrolysis of Nerve-Agent Simulants with a Six-Connected Zirconium-Based Metal-Organic Framework. Angew. Chem. Int. Ed. 2015, 54, 6795-6799; Bobbit et al. Metal-Organic Frameworks for the Removal of Toxic Industrial Chemicals and Chemical Warfare Agents. Chem. Soc. Rev. 2017, 46, 3357-3385), particularly as directed toward the mitigation of CWAs and TICs.

Aerogel forms of metal oxides exhibit promising characteristics for molecular adsorption, chemisorption, and catalytic activity (Klabunde et al. Nanocrystals as Stoichiometric Reagents with Unique Surface Chemistry. J. Phys. Chem. 1996, 100, 12142-12153; Pajonk. Catalytic Aerogels. Catal. Today 1997, 35, 319-337; Rolison. Catalytic Nanoarchitectures: The Importance of Nothing and the Unimportance of Periodicity. Science 2003, 299, 1698-1701; Maleki et al. Current Status, Opportunities and Challenges in Catalytic and Photocatalytic Applications of Aerogels: Environmental Protection Aspects. Appl. Catal. B Environ. 2018, 221, 530-555) arising from high specific—surface area readily accessible to vapor-phase molecules through well-plumbed networks of mesoporous and/or macroporous voids. Aerogel oxides are also inherently rich in surface hydroxyl defects due to the low-temperature sol-gel synthesis, leading to enhanced activity for hydrolysis and specific adsorption. Klabunde and coworkers first showed the efficacy of aerogels for toxic-agent abatement using alkaline-earth oxide compositions (Klabunde), whereas more recent work has demonstrated promising sorption/decomposition of specific agents using either manganese oxide- (Long et al. Manganese Oxide Nanoarchitectures as Broad-Spectrum Sorbents for Toxic Gases. ACS Appl. Mater. Interfaces 2016, 8, 1184-1193) or titania- (DeSario et al. Low-Temperature CO Oxidation at Persistent Low-Valent Cu Nanoparticles on TiO2 Aerogels. Appl. Catal. B Environ. 2019, 252, 205-213; McEntee et al. Mesoporous Copper Nanoparticle/TiO₂ Aerogels for Room-Temperature Hydrolytic Decomposition of the Chemical Warfare Simulant Dimethyl Methylphosphonate. ACS Appl. Nano Mater. 2020, 3(4), 3503-3512) based aerogels.

### BRIEF SUMMARY

Disclosed is a method comprising: providing a zirconium oxy(hydroxide) aerogel, and exposing the aerogel to a liquid, vapor, or gaseous sample suspected of containing a phosphonate compound.

Also disclosed herein is a composition comprising: a zirconium oxy(hydroxide) aerogel. The aerogel is doped with one or more of Fe³⁺ ions, Ce³⁺ ions, SO₄²⁻ ions, Fe²⁺ ions, Ce⁴⁺ ions, NO₃⁻ ions, Cl⁻ ions, CH₃CO₂⁻ ions, oxychlorides, and acetylacetonate ions.

Also disclosed herein is a method comprising: providing a solution comprising: ZrCl₄; a second solute selected from FeCl₃, CeCl₃, Zr(SO₄)₂, Fe³⁺ salts, Fe²⁺ salts, Ce³⁺ salts, Ce⁴⁺ salts, NO₃⁻ salts, Cl⁻ salts, CH₃CO₂ ⁻ salts, oxychlorides, and acetylacetonate salts; and a solvent; adding a cyclic ether to the solution to form a gel; infiltrating the gel with liquid carbon dioxide; applying a temperature and pressure to form supercritical fluid carbon dioxide; and removing the carbon dioxide for form an aerogel.

### BRIEF DESCRIPTION OF THE DRAWINGS

A more complete appreciation will be readily obtained by reference to the following Description of the Example Embodiments and the accompanying drawings.

FIG. 1 shows a Schematic of synthesis, processing, and thermal activation of ZrOₓH_{y} aerogels; photo at right shows monolithic aerogels as collected after supercritical-CO₂ drying.

FIG. 2 shows a proposed scheme for adsorption and decomposition of DMMP at ZrOₓH_{y} surfaces.

FIG. 3 shows simultaneous TGA and DSC traces for ZrOₓH_{y}—as-dried aerogel, heated at 10° C. min⁻¹ under O₂-rich gas flow.

FIG. 4 shows X-ray diffraction scans for a series of calcined ZrOₓH_{y} aerogels. The ZrOₓH_{y}—450° C. and ZrOₓH_{y}—600° C. heat treatments result in a mixed phase indexed as cubic ZrO₂ (ICDD #00-049-1642) and monoclinic ZrO₂ (ICDD #01-083-0943).

FIG. 5 shows pore size-distribution plots derived from N₂-sorption isotherms, using a DFT fitting and assuming cylindrical pore geometry. T-plot analysis of isotherm data for all samples showed no significant surface area or void volume from the micropore (<2 nm) size regime.

FIG. 6 shows high-magnification scanning electron micrographs for ZrOₓH_{y}—450° C. and ZrOₓH_{y}—600° C. aerogels. Samples calcined at lower temperatures could not be clearly imaged by SEM.

FIG. 7 shows ATR-IR absorbance spectra of as-dried and calcined ZrOₓH_{y} aerogels. The spectra are offset vertically for clarity.

FIG. 8 shows Ultrafast MAS ¹H NMR spectra of (top) ZrOₓH_{y}—350° C., (middle) ZrOₓH_{y}—450° C., and (bottom) ZrOₓH_{y}—600° C. aerogel powders, recorded at a spinning rate of 40 kHz.

FIG. 9 shows ATR-IR absorbance spectra of various liquid DMMP and Zr-based substrates after exposure to vapor-phase DMMP. The spectra are offset vertically for clarity. A reference spectrum for each sample was obtained from clean sample immediately before dosing DMMP vapor.

FIG. 10 shows normalized ATR-IR absorbance spectra of as-dried and calcined ZrOₓH_{y} aerogels after exposing to DMMP vapor for 110 min.

FIG. 11 shows bar graph of the coverage ratios of decomposed/molecularly adsorbed DMMP on as-dried and calcined ZrOₓH_{y} aerogels. The values are calculated from the integrated area ratios of ATR-IR spectra at 1220±5 cm⁻¹ (v(P═O)) to 1090±5 cm⁻¹ (vₛ(OPO)).

FIG. 12 shows time-resolved ATR-IR absorbance spectra of ZrOₓH_{y}—350° C. aerogel during humidified (40% RH) DMMP dosing with N₂ carrier gas for 30 min (top) followed by removal of DMMP vapor from gas stream over 3 h (bottom).

FIG. 13 shows infrared spectra sampled from the head-space of an IR gas cell containing 100 mg of either Zr(OH)₄ (left) or ZrOₓH_{y}—350° C. aerogel (right) and 20 μL of DMMP. Spectra were collected as a function of exposure time. The relatively narrow band at 1033 cm' is due to methanol. The broad bands from 1040-1100 cm⁻¹ are ascribed to peaks from vapor-phase molecular DMMP.

FIG. 14 shows ATR-IR spectra of powders exposed to DMMP vapor in a closed vessel for 24 h, followed by outgassing of samples for 8 h. Included are commercial “Type C” Zr(OH)₄, unsubstituted ZrOₓH_{y} aerogel, and Fe- and Ce-containing variants (each at ˜5 atom % versus Zr⁴⁺ content). The labels indicate the temperatures at which each sample was calcined prior to DMMP exposure. The dashed lines indicate peak positions that can be attributed to decomposition products of DMMP.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is the demonstration of the efficacy of zirconia aerogels as active substrates for the sorption and destruction of toxic organophosphorous compounds, such as those used as chemical warfare agents (CWAs). Zirconia aerogels are synthesized via cyclic ether-driven sol-gel chemistry that can be used to produce monolithic forms of the oxide, mitigating the need for binders normally needed with powdered oxides. This sol-gel route is also amenable to doping/substitution of either cation (e.g., Fe³⁺ for Zr⁴⁺) or anion (SO₄²⁻ for O²⁻) or both to tune surface functionality. The through-connected mesoporous networks within the aerogel solid facilitate transport of vapor-phase agents to active sites on the surface; these moieties comprise an oxy(hydroxide) character that promote the hydrolysis and breakdown of said agents, evidenced by in-situ infrared spectroscopy analysis with a chemical warfare agent simulant, dimethylmethylphosphonate (DMMP).

Zirconia-based aerogels offer an opportunity to combine the surface area and porosity advantages of aerogel nanoarchitectures with the known reactivity of Zr—OH surface sites. Early examples of zirconia aerogels were synthesized from zirconium alkoxide precursors (Bedilo et al. Synthesis of High Surface Area Zirconia Aerogels using High Temperature Supercritical Drying. Nanostruct. Mater. 1997, 8, 119-135; Suh et al. Synthesis of High-Surface-Area Zirconia Aerogels with a Well-Developed Mesoporous Texture using CO₂ Supercritical Drying. Chem. Mater. 2002, 14, 1452-1454). An alternative approach that uses more readily available ZrCl₄ as the zirconium source and common cyclic ethers such as propylene oxide or trimethylene oxide as a proton-scavenging agent that drives hydrolysis and condensation to form a gel network (Chervin et al. Role of Cyclic Ether and Solvent in a Non-Alkoxide Sol—Gel Synthesis of Yttria-Stabilized Zirconia Nanoparticles. Chem. Mater. 2006, 18, 4865-4874; Chervin et al. Aerogel Synthesis of Yttria-Stabilized Zirconia by a Non-Alkoxide Sol-Gel Route. Chem. Mater. 2005, 17, 3345-3351; Wu et al. Synthesis of Monolithic Zirconia with Macroporous Bicontinuous Structure via Epoxide-Driven Sol-Gel Process Accompanied by Phase Separation. J. Sol-Gel Sci. Technol. 2014, 69, 1-8). The non-alkoxide method was previously used to prepare Y₂O₃-stabilized ZrO₂ aerogels, which upon calcination crystallized into defective cubic zirconia, a ubiquitous high-temperature oxide conductor used in oxygen sensors and solid-oxide fuel cells. Expressed as an aerogel, zirconia displays remarkable resistance to thermally induced particle growth (Chervin 2006), a characteristic that permits the moderate heating (≥350° C.) required to remove organic byproducts of the cyclic ether-driven synthesis while still maintaining an aerogel-like pore—solid architecture.

From this synthetic route, monolithic or powdered ZrOₓH_{y} aerogels can be prepared that, after an initial thermal treatment to remove organic byproducts of the cyclic ether-driven synthesis exhibit excellent activity for the breakdown of dimethylmethylphosphonate (DMMP), a well-known simulant for organophosphorous CWAs. The introduction of certain metal substituents, namely Fe³⁺ and Ce³⁺, into the sol-gel synthesis can yield zirconia aerogel compositions with further enhanced activity for DMMP decomposition, as well as additional reactivity for other classes of chemical warfare agents and pesticides including, but not limited to mustard gas agents and derivatives thereof.

Zirconia aerogels exhibit hydroxyl functionality reminiscent of “hydrous zirconia,” a relative of Zr(OH)₄, but in a form that is more thermally stable and resistant to dissolution (Huang et al. Differences Between Zirconium Hydroxide (Zr(OH)₄⋅nH₂O) and Hydrous Zirconia (ZrO₂⋅nH₂O). J. Am. Ceram. Soc. 2001, 84, 1637-1638). As verified by in-situ infrared spectroscopy, hydrous zirconia aerogels (denoted here as ZrOₓH_{y}) exhibit significant activity for hydrolytic decomposition of dimethyl methylphosphonate (DMMP), a well-known simulant for organophosphorus CWAs. Reactivity of a series of thermally processed ZrOₓH_{y} aerogels can be correlated to their hydroxyl content, degree of crystallinity, and specific surface area. Zirconia aerogels calcined above 350° C. exhibit DMMP-decomposition mechanisms comparable to those observed with state-of-the-art Zr(OH)₄, but maintain reactivity and aerogel-like porosity even after thermal treatment at 600° C.

The zirconia aerogels may be synthesized using a non-alkoxide sol-gel protocol adapted from a method previously reported for Y₂O₃-stabilized zirconia (Bedilo; Chervin 2006). This procedure is based on the reaction of concentrated aqueous or alcohol-based solutions of the ZrCl₄ with a cyclic ether such as propylene oxide, which serves as a proton scavenger that promotes the hydrolysis of dissolved Zr⁴⁺ and ultimate formation of a fluid-filled ZrOₓH_{y} gel. Note that cation or anion substitution into the ZrOₓH_{y} may also be accomplished by adding minor amounts of another metal salt (e.g., FeCl₃ or CeCl₃ for cation substitution, or Zr(SO₄)₂ for anion substitution or a double substitution of cation and anion) to the initial precursor solution. Such substitutions may be advantageous in promoting the formation and activity of specific surface functionalities, for example Zr—OH or under-coordinated Zr^{4 +}. The dopant may be, for example, uniformly distributed in the aerogel or in the form of a layer on the aerogel.

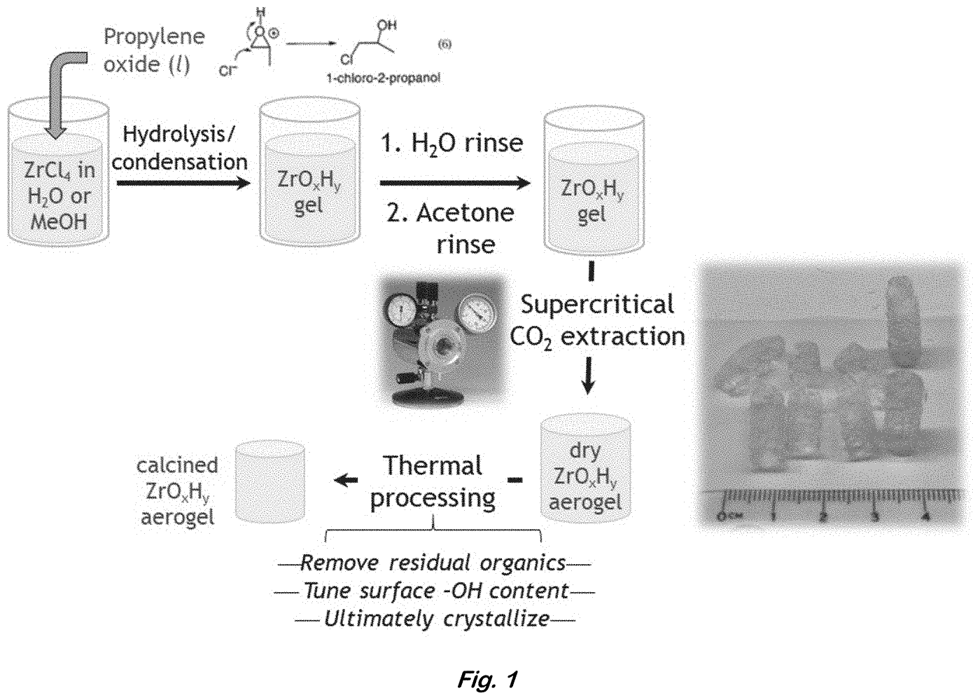

In one suitable synthesis of ZrOₓH_{y} aerogels (FIG. 1), anhydrous ZrCl₄ is dissolved in H₂O, and the resulting solution then chilled to ˜2° C. To the chilled ZrCl₄ solution, propylene oxide (also pre-chilled to 2° C.) is added in one aliquot. This solution is poured into small molds (e.g., plastic vials), in which a rigid ZrOₓH_{y} gel forms within a few minutes. Thus, the size and shape of the vessel determines, in part, the dimensions of the ultimate ZrOₓH_{y} aerogel. Allowing the wet ZrOₓH_{y} gel to age for one or two days typically yields a stronger monolith, although in some cases the gel will exhibit some macroscale cracks during subsequent rinsing steps. Gels are first rinsed in water to remove any unreacted ZrCl₄, then with several aliquots of acetone over 2-3 days. The acetone-exchanged gels are then transferred to an autoclave and the acetone exchanged with liquid CO₂ at ˜10° C. Following several flushes with CO₂ to fully remove any remaining acetone, the vessel is heated to ˜41° C., while the internal pressure increased to ˜8.6 MPa, bringing CO₂ past its critical point (T_{c} 31° C.; Pc 7.4 MPa). Following the release of supercritical CO₂ from the autoclave, monolithic pieces of ZrOₓH_{y} aerogel are collected.

The as-prepared ZrOₓH_{y} aerogel is a structurally disordered material that also contains residual organic- and chlorine-containing byproducts of the cyclic ether-driven synthesis that may passivate or block active sites on the oxide surface. Subsequent thermal processing is required to remove such byproducts and to tune the hydroxyl functionality of the ZrOₓH_{y} aerogel. Simultaneous thermogravimetric analysis (TGA) and differential scanning calorimetry (DSC) may be used to track the thermal evolution of the ZrOₓH_{y} aerogels and determine optimal heat-treatment protocols.

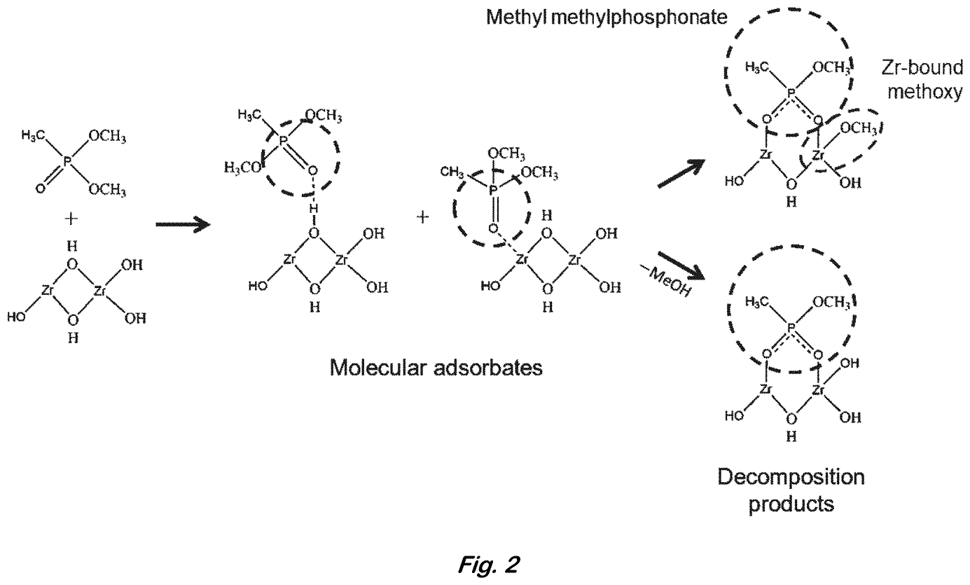

The aerogel, with or without a dopant, may be used for decontamination of phosphonate compounds such as CWAs and DMMP and mustard gas compounds such as bis(2-chloroethyl)sulfide (HD, mustard gas). A proposed reaction scheme for phosphonate containing compounds is shown in FIG. 2. As shown in the scheme, the aerogel form can result in the retention of a portion of the methanol that is generated.

The zirconia aerogels may provide several advantages with respect to the mitigation of organophosphorus CWAs under practical operating conditions, particularly compared to Zr(OH)₄, as highlighted below.
Effective decomposition of CWA simulant, DMMP, under both dry and wet environments, with activity comparable to that of commercial Zr(OH)4
Limited release of toxic methanol byproducts upon DMMP exposure, minimizing secondary contamination hazards (Zr(OH)₄ readily evolves large quantities of methanol)
Conversion of mustard gas agents to less toxic hydrolysis products
Ability to be synthesized in a monolithic form factor that retains through-connected pore networks to interior surface sites (Zr(OH)₄ powder typically requires formulation with binders to prepare pellets for certain applications diluting active sites per gram of formulated solid)
Stabilization of surface hydroxyl groups and their associated reactivity for DMMP decomposition, even to relatively high treatments (600° C.) and crystallization to a nominal ZrO₂ structure (commercial Zr(OH)₄ loses significant activity after treatment to 500° C. or higher) (Bandosz)
Adaptability of cyclic ether-driven sol-gel chemistry to form factors beyond monoliths and powders, including coatings of active ZrOₓH_{y} on fibers and fabrics.

Zirconium hydroxide, which is structurally similar to the zirconia aerogel, is also known to hydrolyze mustard gas class of compounds (Bandosz et al. Reactions of VX, GD, and HD with Zr(OH)₄: Near Instantaneous Decontamination of VX. J. Phys. Chem. C 2012, 116, 11606-11614). Similar reactivity is also expected for the zirconia aerogel. Such chlorothio compounds include, but are not limited to, bis(2-chloroethyl)sulfide (Mustard); 1,2-bis-(2-chloroethylthio)-ethane (Sesquimustard); bis-(2-chloroethylthioehtyl)-ether (O-Mustard); 2-chloroethyl chloromethyl sulfide; bis-(2-chloroethylthio)-methane; bis-1,3-(2-chloroethylthio)-n-propane; bis-1,4,(2-chloroethylthio)-n-butane; bis-1,5-(2-chloroethylthio)-n-pentane; and bis-(2-chloroethylthiomethyl)-ether.

The following examples are given to illustrate specific applications. These specific examples are not intended to limit the scope of the disclosure in this application.

In a typical lab-scale synthesis of ZrOₓH_{y} aerogels, 4.6 g of anhydrous ZrCl₄ was dissolved in 40 mL of H₂O and the resulting solution chilled to ˜2° C. To the chilled ZrCl₄ solution, 15 mL of propylene oxide (also pre-chilled to ˜ 2° C.) was added in one aliquot and the solution stirred for ˜30 s before either pouring the liquid into high-density polypropylene molds or allowing the sol to gel in the synthesis beaker. The size and shape of the vessel determines, in part, the dimensions of the ultimate ZrOₓH_{y} aerogel. Allowing the wet ZrOₓH_{y} gel to age in the mother liquor for one or two days typically yields a stronger monolith, although in some cases the gel will exhibit some macroscale cracks during subsequent rinsing steps that affect the dimensions and optical clarity of the dried aerogels. The solution was covered with PARAFILM® and a rigid gel formed within 5 to 10 min. The gel was aged for 18-48 h at ambient temperature and then rinsed in 18 MΩ cm water for 24 to 48 h, changing the water twice per day to remove unreacted ZrCl₄. The water was then exchanged with acetone over 2-3 days using two exchange-aliquots of acetone per day. The gels were transferred to an autoclave and the pore-filling fluid exchanged with liquid CO₂ at ˜10° C. Following ˜6 flushes with CO₂ to fully remove any remaining acetone, the vessel was heated to ˜41° C., while the internal pressure increased to ˜8.6 MPa, bringing CO₂ past its critical point (Tc=31° C.; Pc=7.4 MPa). The autoclave was then vented to yield a dried ZrOₓH_{y} aerogel.

The as-dried aerogels were heated to select temperatures (250-600° C.) at 2° C. min⁻¹ with a 4-h hold at the desired temperature followed by a 2° C. min⁻¹ cooling ramp.

The ZrOₓH_{y} aerogels were characterized with X-ray diffraction (XRD), N₂-porosimetry, thermal analysis, scanning electron microscopy (SEM), and solid-state nuclear magnetic resonance (NMR) spectroscopy. The X-ray diffraction profiles were collected using a Rigaku Smart Lab X-ray diffractometer operating with Cu K-α radiation (λ=1.5406 Å) at 40 kV and 44 mA. The diffractometer was equipped with Bragg-Brentano optics and a D/tex detector. Samples were scanned from 10-80° 2θ in continuous mode with a 5-s integration time. Surface area and pore volume were measured with N₂-sorption porosimetry using a Micromeritics ASAP 2020. Samples were degassed for 12 h at 80° C. under vacuum prior to analysis. Specific surface area was calculated using the Brunauer-Emmett-Teller (BET) method based on the linear portion of the adsorption isotherm. Pore volumes were calculated using the Barrett-Joyner-Halenda (BJH) method, fitting data across the entire range of the isotherm. Thermogravimetric analysis coupled with differential scanning calorimetry (TGA/DSC) of the as-dried ZrOₓH_{y} aerogel performed with a Netzsch Jupiter STA 449 F1 thermal analyzer. Samples were heated at 10° C. min⁻¹ under a gas flow comprising a 60/40 ratio of O₂ to Ar. Scanning electron microscopy (SEM) of the ZrOₓH_{y} aerogels heated to 450 and 600° C. was performed using a Carl Zeiss Leo Supra MM electron microscope operating at 20 keV. Samples were ground to a fine powder, dispersed in ethanol with sonication, and then a drop of the slurry was placed onto pre-heated aluminum SEM stubs (120° C.).

NMR measurements were made on an Agilent NMR spectrometer at a ¹H frequency of 500.1 MHz using ultrafast magic angle spinning (MAS). All measurements were made at 30° C. and using a spin rate of 40 kHz. Background signals were removed by a combination long pulse/short pulse difference to remove the probe background and subtraction of the fitted rotor background signal. Samples were packed in 1.2 mm rotors and stored over DRIERITE™ with the rotor caps removed prior to use in NMR studies. Chemical shifts are externally referenced to hexamethylbenzene.

The reactions of DMMP with Zr(OH)₄, monoclinic ZrO₂ (m-ZrO₂), and ZrOₓH_{y} aerogels were investigated using an FTIR spectrometer (Bruker Vertex 70v) equipped with an ATR accessory (Harrick Scientific Horizon) and a mercury cadmium telluride (MCT) detector. Scans were collected with a 20 kHz scanning velocity, Norton-Beer strong apodization correction, Mertz interferogram phase correction, 4 cm⁻¹ resolution, and zero-filling of 4. Gas dosing was performed using a multigas manifold with MKS flow controllers to maintain consistent gas flow. The DMMP vapor was produced by flowing dry N₂ through a gas-dispersion tube submerged in liquid DMMP at room temperature. All gases were then mixed and flowed through a silica-coated, stainless-steel ATR gas-flow cell and exhausted into a bleach bubbler.

Dispersions of ZrOₓH_{y}aerogels were prepared by adding ˜30 mg of powdered aerogels to 1.5 mL of deionized water. The suspensions were sonicated for ˜2 h with intermittent vortexing to resuspend settled particulate. Thin adherent films were formed by drop-casting 500-μL aliquots of ZrOₓH_{y} aerogel dispersion onto a ZnSe ATR-IR internal reflection element (IRE). Films comprising Zr(OH)₄ or ZrO₂ powders were prepared similarly. After film casting, the IREs were dried overnight under N₂. All samples were then secured in a gas-flow cell and sealed. The optical compartments of the instrument were evacuated to <1 hectopascal (<1 mbar), while the samples inside the flow cell remained at ambient pressure. The samples were stabilized for ˜1 h before dosing.

The flow cell was purged for at least 2 h under dry UHP N₂ to remove any loosely bound surface contaminants and moisture from the ZrOₓH_{y} aerogel surface. Unless otherwise noted, time-resolved difference spectra are colored from blue (initial) to red (final) to highlight spectral changes over time. No additional ATR corrections were performed. All samples were purged under dry UHP N₂ (25 sccm) for 61 min while collecting spectra every minute. After purging, gas flow to the sample chamber was bypassed and DMMP (0.5 sccm) was combined with 24.5 sccm UHP N₂. Spectra were collected each minute for a total of 31 acquisitions. After the first acquisition, the gas mixture containing DMMP vapor was directed back into the sample chamber over the zirconia aerogel thin film. After 31 acquisitions were collected, DMMP dosing was stopped and the UHP N₂ flow rate was returned to 25 sccm to perform the final purging step while collecting spectra every minute for at least 1 h.

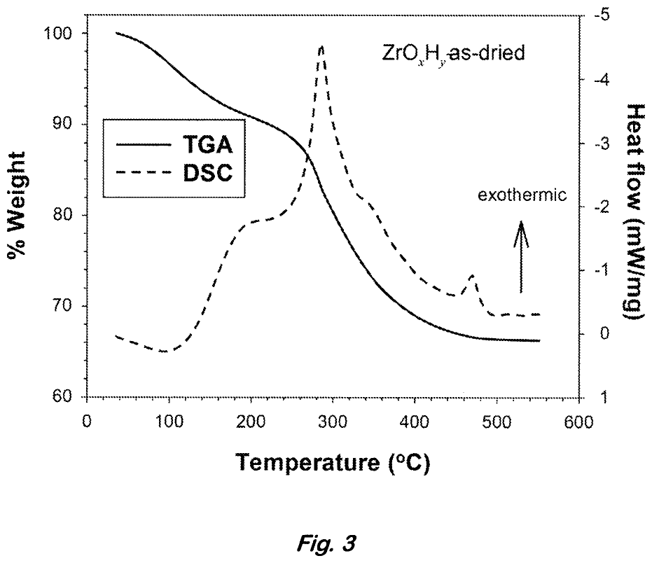

The as-dried ZrOₓH_{y} aerogel is a structurally disordered material in which residual organic and chlorine-containing byproducts of the cyclic ether-driven synthesis remain (Chervin et al. Aerogel Synthesis of Yttria-Stabilized Zirconia by a Non-Alkoxide Sol-Gel Route. Chem. Mater. 2005, 17, 3345-3351); these species risk passivating or blocking active sites on the oxide surface. Subsequent thermal processing is required to remove such byproducts and to tune the hydroxyl content of the ZrOₓH_{y} aerogel. Simultaneous thermal analysis (TGA/DSC) was used to track the thermal evolution of the ZrOₓH_{y} aerogels and determine optimal heat-treatment protocols. The as-dried ZrOₓH_{y} aerogel loses ˜11% of its mass, accompanied by a broad endothermic DSC feature upon heating to 250° C. (FIG. 3). This weight loss is attributed to desorption of physisorbed and chemisorbed water, as well as residual organics.

Heating further to 350° C. causes an additional 15% weight loss associated with a sharp exothermic peak at 285° C., which is attributed to condensation of Zr—OH to form additional Zr—O—Zr bonding (Huang). The weight loss associated with the removal of hydroxyl moieties continues up to 450° C. for another 6% loss, but beyond that temperature, minimal additional weight loss occurs (— 1%). Yttria-stabilized ZrO₂ aerogels also prepared by the cyclic ether sol-gel method had similar thermal properties as the pure zirconia aerogel shown here, featuring exothermic oxidation of organics, endothermic desorption of water below 200° C., and dehydration of hydroxides to form M—O—M bonds from 200 to ˜405° C. (Chervin 2005).

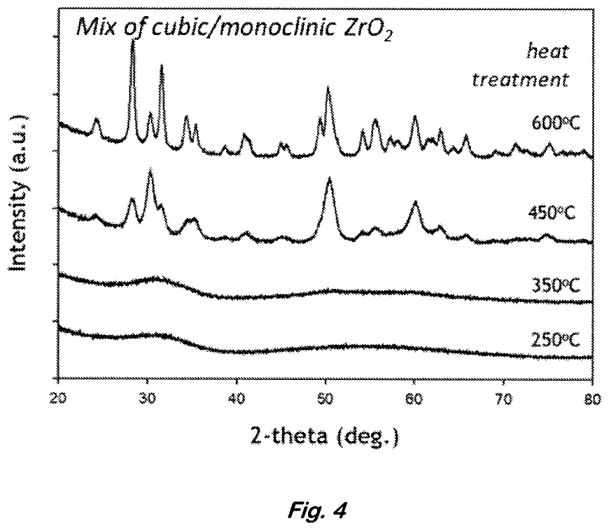

Based on the TGA/DSC results, a series of ZrOₓH_{y} aerogels were prepared that were heated to 250, 350, 450, or 600° C. in static air using a 5-h dwell time at the selected temperature (T). For shorthand purposes in the following discussion, the designation “ZrOₓH_{y}—as-dried” is used for the unheated aerogel and “ZrOₓH_{y}—T° C.” for calcined analogues. The degree of crystallinity and crystalline phase of the ZrOₓH_{y}—as-dried and heated aerogels were characterized with powder X-ray diffraction (FIG. 4), while specific surface area, pore volume, and pore-size distribution of the ZrOₓH_{y} aerogel series are determined via N₂-physisorption methods (see summary of metrics in Table 1).

TABLE 1
Summary of N₂-sorption and XRD results
for the ZrOₓH_{y} aerogel series

| | BET specific | Specific pore | |
|---|---|---|---|
| | surface area | volume | |
| ZrOₓH_{y} aerogel | (m² g⁻¹)^{a} | (cm³ g⁻¹)^{b} | Crystallinity |
| ZrOₓH_{y}-as-dried | 726 | 2.3 | Amorphous |
| ZrOₓH_{y}-250° C. | 591 | 0.97 | Amorphous |
| ZrOₓH_{y}-350° C. | 234 | 0.38 | Amorphous |
| ZrOₓH_{y}-450° C. | 108 | 0.32 | Nanocrystalline |
| ZrOₓH_{y}-600° C. | 30 | 0.19 | Nanocrystalline |

^{a}Specific surface area values were calculated according to the multipoint Brunauer-Emmett-Teller method.
^{b}Cumulative specific pore volume values were calculated with the Barrett-Joyner-Halenda method.

The ZrOₓH_{y}—as-dried aerogel has a high specific surface area and pore volume (726 m²g⁻¹ and 2.3 cm³g⁻¹, respectively) and is X-ray amorphous (not shown). Surface area remains relatively high upon heating to 250 and 350° C. (591 and 234 m²g⁻¹, respectively) with no change in the amorphous nature of the ZrOₓH_{y} aerogels (FIG. 4). Specific surface area decreases to 108 m²g⁻¹ concomitant with the crystallization that occurs with heating at 450° C., as evidenced by broad XRD peaks that index to cubic and monoclinic ZrO₂ (calculated average crystallite sizes are 9.6 and 7.7 nm, respectively). The cubic phase accounts for 46% of the crystallinity and monoclinic for the other 54%. Heating to 600° C. further decreases the surface area to 30 m²g⁻¹, accompanied by sharpening of the XRD peaks. A mixture of cubic and monoclinic phases is retained, but the monoclinic fraction increases to 88% and the grain sizes markedly diverge such that the average crystallite sizes of the cubic and monoclinic phases are 39 and 13 nm, respectively. Even after

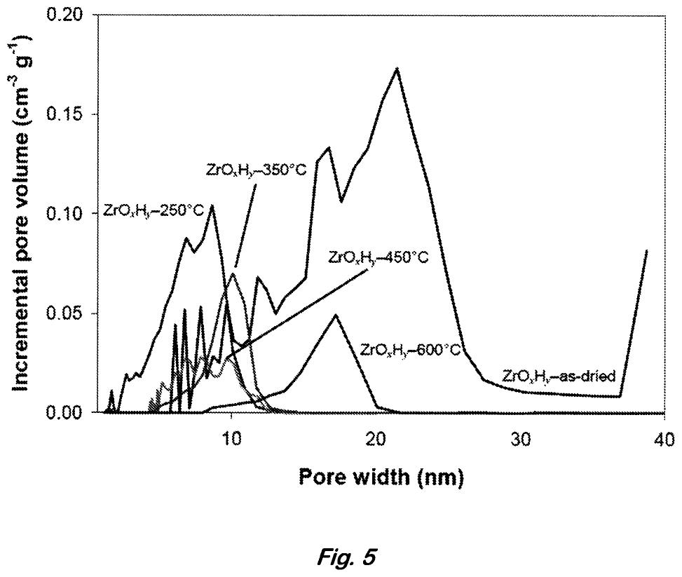

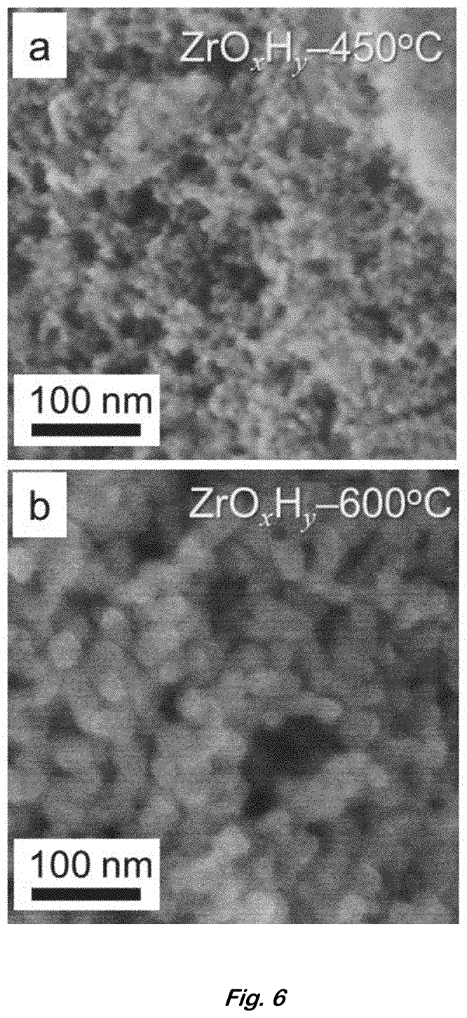

calcination and crystallization at these higher temperatures (450 and 600° C.), the ZrOₓH_{y} aerogel retains specific surface area and porosity superior to common forms of metal oxides, as evidence by N₂-sorption metrics and pore size-distribution plots (FIG. 5), as well as by imaging with SEM (see FIG. 6).

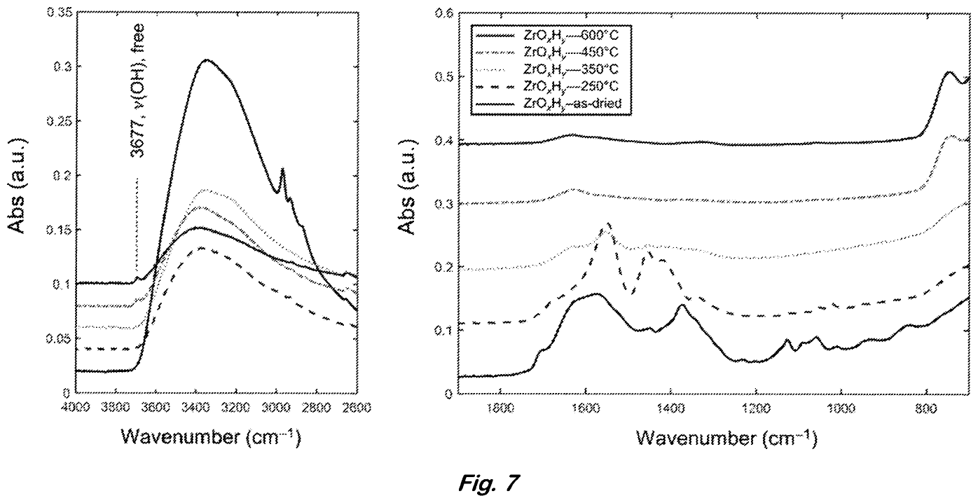

Attenuated total reflectance infrared (ATR-IR) spectroscopy is used to characterize surface adsorbates on the ZrOₓH_{y}—as-dried and calcined ZrOₓH_{y} aerogels, as shown in FIG. 7. The ZrOₓH_{y}—as-dried aerogel exhibits broad and complex IR bands between 1700-800 cm⁻¹, suggesting that adsorbed organic residue from the synthesis remains within the aerogel. The vibrational bands near 1530, 1372, 1092, 1058, and 843 cm⁻¹ are ascribed to an interfacial carbonate complex formed between carbonate adsorbates (Balow) and the partially hydrated ZrOₓH_{y} aerogel surface. Additionally, v(C—H) stretching modes indicative of hydrocarbon impurities appear near 2974, 2931, and 2872 cm⁻¹. The vibrational mode at 1704 cm⁻¹ in the ZrOₓH_{y}—as-dried aerogel ATR spectrum is typical of carbonyl moieties and may result from a side reaction with propylene oxide during synthesis (Chervin 2005; Long et al. Nanocrystalline Iron Oxide Aerogels as Mesoporous Magnetic Architectures. J. Am. Chem. Soc. 2004, 126, 16879-16889). This vibrational mode is still observed, albeit redshifted to 1680 cm⁻¹ after calcination at 250° C.

The amount of IR-detectable carbonaceous species diminishes markedly with calcination at temperatures ≥350° C., in agreement with weight losses observed by TGA. The IR bands in the 3200-3400 cm⁻¹ range are associated with the v(OH) modes of hydrogen-bonded water. Surface water concentration is highest for the ZrOₓH_{y}—as-dried aerogel, with incremental losses occurring at increasing calcination temperatures. Isolated surface OH species, indicated by the narrow band at 3677 cm⁻¹, are only observed for aerogels calcined at 350° C. and above. Moreover, the intensity of the v(OH) band for isolated OH species increases with temperature. It is possible that calcination temperatures near 350° C. clean the aerogel surface by desorbing or reacting adsorbed carbonaceous species, exposing additional free surface hydroxyl species and ultimately improving the decontamination performance of ZrOₓH_{y} aerogels. When heated above 450° C., the ZrOₓH_{y} aerogel begins crystallizing to ZrO₂, accompanied by some diminution of OH/H₂O vibrational modes; however, even after calcination at 600° C., a hydrophilic, hydroxylated surface remains (FIG. 7).

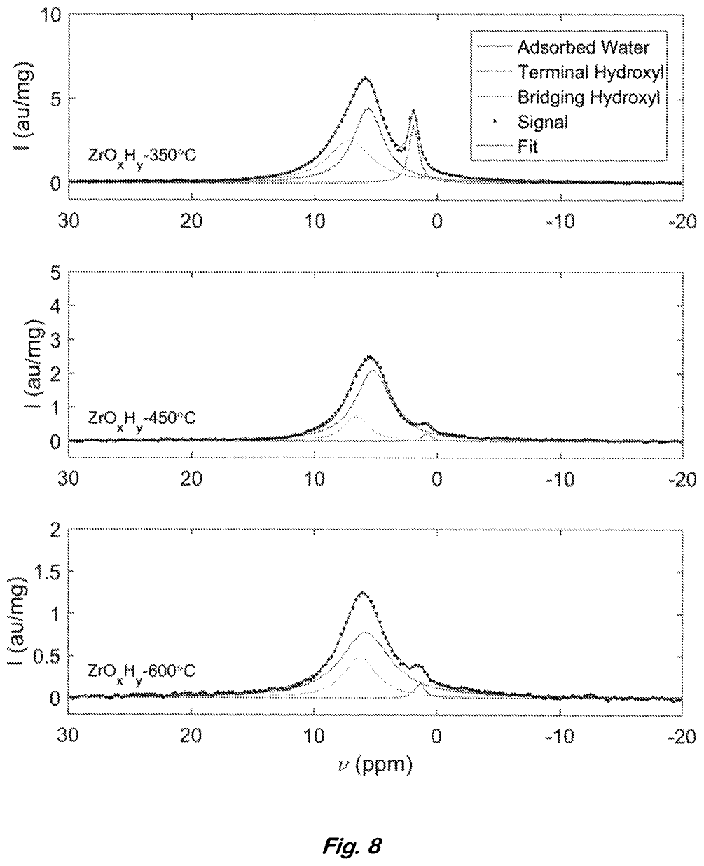

To complement the IR analysis and further probe the hydroxyl character of these materials, the calcined aerogel samples, ZrOₓH_{y}—350° C., ZrOₓH_{y}—450° C., and ZrOₓH_{y}—600° C. were characterized with ultrafast magic angle spinning (MAS)¹1H NMR spectroscopy. Spectra of the materials dried over DRIERITE™ desiccant for several days show three resonances attributable to adsorbed water, terminal hydroxyl groups, and bridging hydroxyl groups (FIG. 8). The resonance near 5.5 ppm is assigned to water, based on experiments where the selected aerogels were dried over excess desiccant for varying times. Only this resonance shows a consistent decrease in amplitude with drying time. The chemical shift of the water peak is consistent with that reported for Zr(OH)₄ (Mogilevskyet al. Surface Hydroxyl Concentration on Zr(OH)₄ Quantified by ¹H MAS NMR Chem. Phys. Lett. 2011, 511, 384-388).

The resonance near 1 ppm is assigned to terminal hydroxyl groups (Mastikhin et al. ¹H Magic Angle Spinning (MAS) Studies of Heterogeneous Catalysis. Prog. NMR Spectro. 1991, 23, 259-299). The third resonance is at higher frequency (between 6 and 7 ppm), higher than what is reported for resonances in previous studies of ZrOₓH_{y}. Protons at Lewis acid sites may fall in this range (Hunger et al. Magic-Angle Spinning Nuclear Magnetic Resonance Studies of Water Molecules Adsorbed on Brønsted- and Lewis-acid Sites in Zeolites and Amorphous Silica-Aluminas. J. Chem. Soc. Faraday Trans. 1991, 87, 657-662), thus, the third resonance is tentatively assigned to bridging hydroxyls. The fact that the bridging hydroxyl peak is found at higher frequency and the terminal hydroxyl peak at the lower range of frequencies than previously observed for zirconia materials suggests that these aerogels express hydroxyls that are of more acidic and basic nature, respectively. A previous report on crystalline ZrO₂ also noted a ¹H NMR peak at 4.9 ppm, assigned to hydroxyl within the crystal structure of ZrO₂ (Chadwick et al. Solid-State NMR and X-Ray Studies of the Structural Evolution of Nanocrystalline Zirconia. Chem. Mater. 2001, 13, 1219-1229); that peak is not clearly observed in the calcined ZrOₓH_{y} aerogels, but may be obscured by close proximity to the intense adsorbed water peak.

Quantitative results from the NMR spectra are summarized in Table 2, with peak areas normalized to the mass of the sample studied. The trend in normalized peak area ascribed to adsorbed water is consistent with the decreasing specific surface area with progressively higher calcination temperatures (Table 1). The peak-area ratio of bridging-to-terminal hydroxyl for ZrOₓH_{y}—350° C. is 3.49, in agreement with previous NMR studies of zirconia materials (Bandosz; Iordanov; Mastikhin et al. ¹H Magic Angle Spinning (MAS) Studies of Heterogeneous Catalysis. Prog. NMR Spectro. 1991, 23, 259-299; DeCoste et al. Trifluoroethanol and ¹⁹F Magic Angle Spinning Nuclear Magnetic Resonance as a Basic Surface Hydroxyl Reactivity Probe for Zirconium(IV) Hydroxide Structures. Langmuir 2011, 27, 9458-9464). These two peaks show a decrease in area when calcination temperature increases from 350 to 450° C., suggesting reaction of the acidic bridging hydroxyl proton with basic terminal hydroxyl to form water that is removed during heating. A 15-fold decrease in the terminal hydroxyls and a 6-fold decrease in the bridging hydroxyls are observed. No further decrease is observed in either peak for ZrOₓH_{y}—600° C., consistent with the IR spectroscopy results discussed above.

TABLE 2
Summary of ¹H NMR results for selected ZrOₓH_{y} aerogels.

| | | | Position | Width |
|---|---|---|---|---|
| | Aerogel sample | Area/mg | (ppm) | (ppm) |
| Adsorbed | ZrOₓH_{y}-350° C. | 8.48 ± 0.06 | 5.51 ± 0.02 | 2.97 ± 0.07 |
| water | ZrOₓH_{y}-450° C. | 4.66 ± 0.04 | 5.09 ± 0.08 | 3.45 ± 0.09 |
| | ZrOₓH_{y}-600° C. | 2.49 ± 0.38 | 5.67 ± 0.40 | 4.97 ± 1.25 |
| Terminal | ZrOₓH_{y}-350° C. | 2.02 ± 0.01 | 1.80 ± 0.03 | 0.91 ± 0.01 |
| hydroxyl | ZrOₓH_{y}-450° C. | 0.13 ± 0.01 | 0.72 ± 0.05 | 0.93 ± 0.17 |
| | ZrOₓH_{y}-600° C. | 0.11 ± 0.01 | 1.22 ± 0.05 | 0.96 ± 0.20 |
| Bridging | ZrOₓH_{y}-350° C. | 7.04 ± 0.07 | 7.04 ± 0.09 | 4.37 ± 0.08 |
| hydroxyl | ZrOₓH_{y}-450° C. | 1.11 ± 0.04 | 6.48 ± 0.10 | 2.34 ± 0.28 |
| | ZrOₓH_{y}-600° C. | 1.00 ± 0.30 | 6.11 ± 0.31 | 3.19 ± 1.62 |

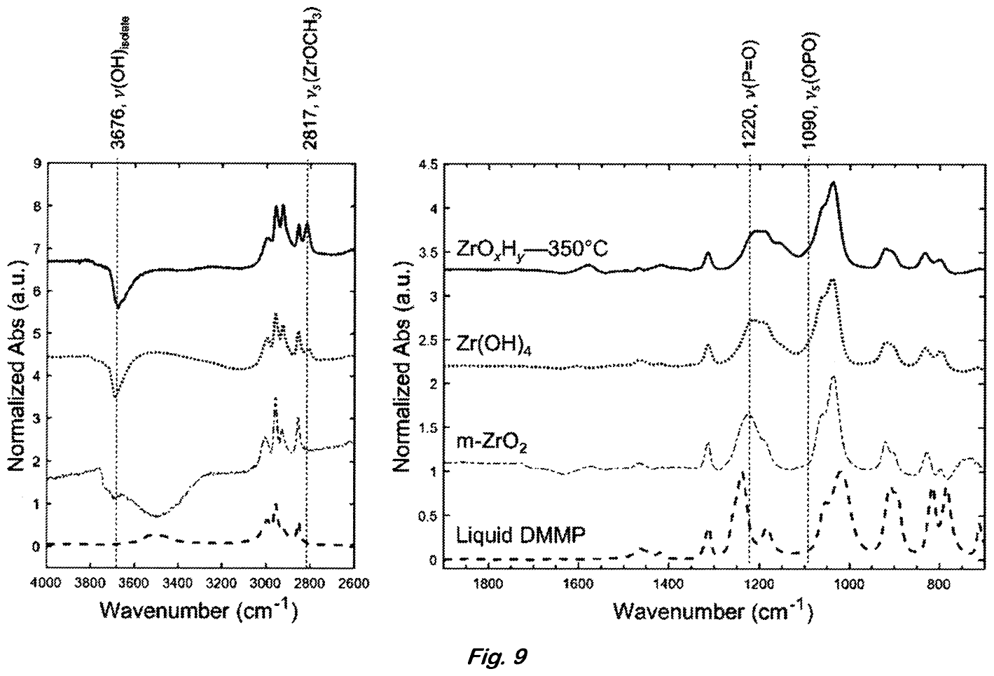

The prospects for using ZrOₓH_{y}aerogels to mitigate CWAs were evaluated by room-temperature adsorption/decomposition reaction with DMMP as monitored using in-situ ATR-IR spectroscopy. FIG. 9 compares normalized ATR spectra of three representative Zr-based substrates—commercial monoclinic ZrO₂ (m-ZrO₂), Zr(OH)₄, and ZrOₓH_{y}—350° C. aerogel—after their exposure to vapor-phase DMMP, along with the spectrum of liquid DMMP. The phosphoryl v(P═O) mode of DMMP is quite sensitive to its local environment (Rusu et al. Adsorption and Decomposition of Dimethyl Methylphosphonate on TiO₂. J. Phys. Chem. B 2000, 104, 12292-12298), in this case red-shifting from 1240 cm⁻¹ for the neat liquid to 1230-1190 cm⁻¹ upon adsorption at these zirconia substrates, indicating specific adsorption via the phosphoryl bond. A loss in isolated surface hydroxyls at 3676 cm⁻¹ (v(OH)) with the concomitant gain of both the asymmetric and symmetric v(OPO) bridging modes near 1155 and 1090 cm⁻¹, respectively, suggests rapid decomposition of DMMP via hydrolysis for Zr(OH)₄ and the ZrOₓH_{y}—350° C. aerogel (FIG. 9, right). Surface-bound methoxy and the other decomposition product, methanol, are observed by formation of the v(Zr—OCH₃) mode at 2817 cm⁻¹ and gaseous methanol in the headspace (discussed later). These reaction byproducts are typical for hydrolysis reactions and have been previously reported for Zr(OH)₄ (FIG. 2) (Balow; Jeon et al. Kinetics of Dimethyl Methylphosphonate Adsorption and Decomposition on Zirconium Hydroxide Using Variable Temperature In Situ Attenuated Total Reflection Infrared Spectroscopy. ACS Appl. Mater. Interfaces 2020, 12, 14662-14671).

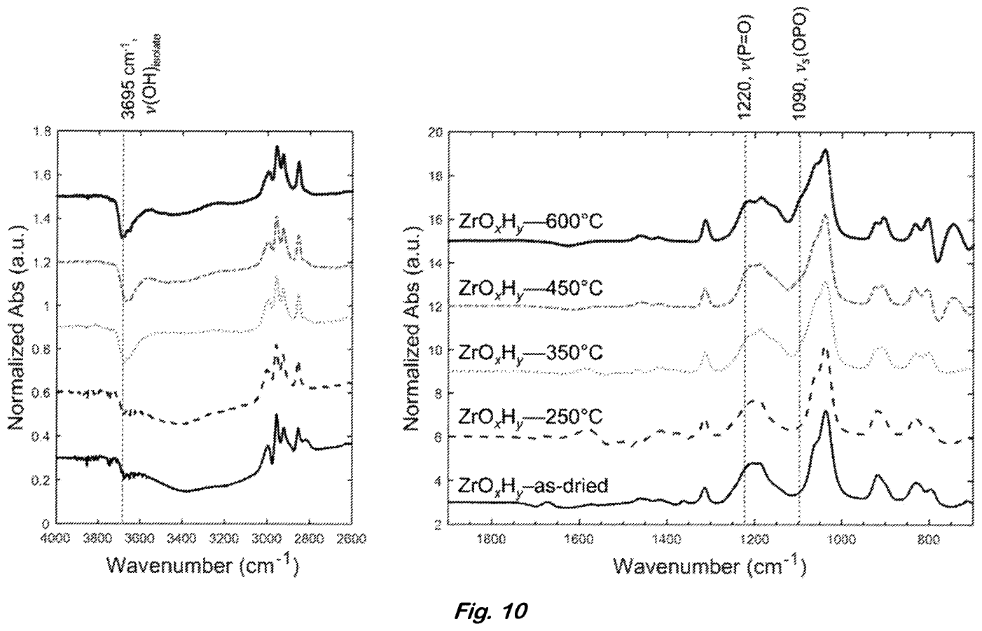

Similar measurements are performed for the entire series of ZrOₓH_{y} aerogels to correlate DMMP sorption/decomposition with specific thermal treatment; representative ATR-IR spectra are shown in FIG. 10. After room-temperature exposure to DMMP for 110 min, increased coverage of both molecular and decomposed adsorbates are observed at 1220 cm⁻¹ (v(P═O )), 1155 cm⁻¹ (vₐ(OPO)), and 1090 cm⁻¹ (vₛ(OPO)). Simultaneous loss of isolated hydroxyl species at 3695 cm⁻¹ (v(OH)) supports a DMMP hydrolysis/decomposition mechanism on all aerogel samples, but with the most distinct change in hydroxyl signature for ZrOₓH_{y} aerogels calcined at temperatures >350° C.

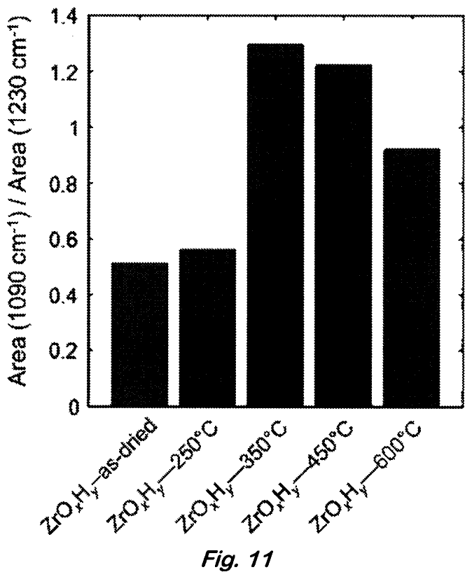

While both molecular adsorption and decomposition products are observed on all samples, the relative coverages of decomposition products to molecular adsorbates vary. Relative DMMP decomposition performance was estimated as a function of thermal treatment for the ZrOₓH_{y} aerogel series by calculating the integrated area ratios of decomposition products (represented by v(OPO) at 1090 cm⁻¹) to molecular adsorbates (represented by v(P═O) at 1220 cm⁻¹) (FIG. 10) (Panayotov et al. Uptake of a Chemical Warfare Agent Simulant (DMMP) on TiO₂: Reactive Adsorption and Active Site Poisoning. Langmuir 2009, 25, 3652-3658; Wang et al. Mechanism and Kinetics for Reaction of the Chemical Warfare Agent Simulant, DMMP(g), with Zirconium(IV) MOFs: An Ultrahigh-Vacuum and DFT Study. J. Phys. Chem. C 2017, 121, 11261-11272). The bar graph in FIG. 11 shows rapidly increasing DMMP-decomposition activity after calcination at 350° C. to remove organic byproducts of the synthesis. Decomposition activity decreases modestly as the calcination temperature is increased to 450 and 600° C., consistent with conversion of amorphous aerogel to crystalline ZrO₂ and decrease in specific surface area. Yet, even after 600° C. calcination, the ZrOₓH_{y} aerogel retains appreciable activity for DMMP decomposition, evidence that active surface hydroxyl functionality persists even after calcination at such high temperatures.

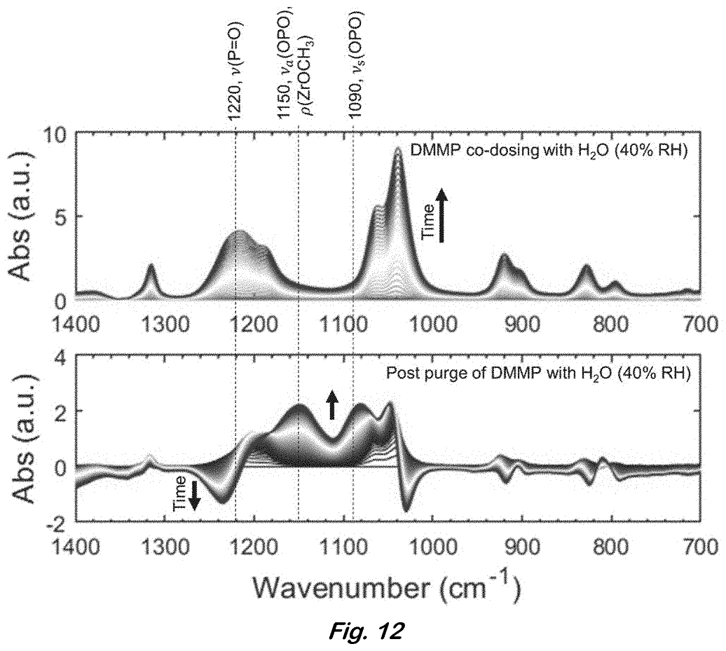

The ZrOₓH_{y}aerogels also demonstrate robust stability and rapid decomposition of DMMP under 40% relative humidity (RH). The top spectrum in FIG. 12 shows an increase in IR absorbance at 1220 cm⁻¹ (v(P═O)), 1150 cm⁻¹ (Vₐₛ(OPO) & ρ(ZrOCH3)), and 1090 cm⁻¹ (vₛ(OPO)), indicating that both molecular adsorption and decomposition reactions remain operative at the humidified ZrOₓH_{y}—350° C. aerogel surface. When DMMP vapor is removed from the humidified gas stream, the DMMP continues to decompose on the aerogel via hydrolysis to form additional methoxy (1150 cm⁻¹) and bridging v(OPO) (1150 cm⁻¹ and 1090 cm⁻¹) decomposition species. Loss of intensity around 1230 cm⁻¹ indicates either destruction and/or desorption of loosely bound molecular DMMP. Regardless of humidity, once DMMP decomposition products are formed at the ZrOₓH_{y} surface, phosphorus-based products remain trapped within the material. These observations suggest ZrOₓH_{y} aerogels offer great promise as thermally and environmentally robust, multifunctional decontamination sorbents for phosphonate-based CWAs such as VX, sarin, and soman.

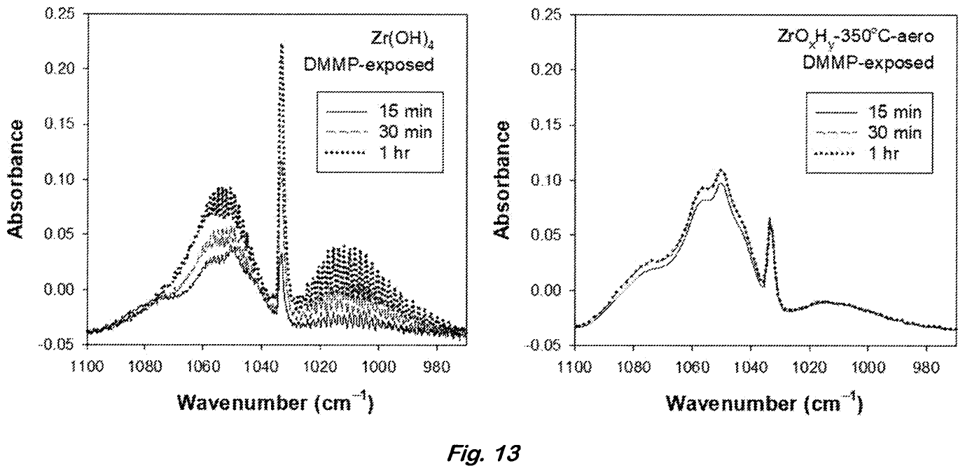

The propensity of zirconia materials to evolve gas-phase byproducts, such as methanol, upon reaction with DMMP is assessed by performing IR measurements through the head-space of gas cells that contain the relevant substrate and DMMP (FIG. 13). The presence of vapor-phase methanol is shown by rotationally resolved lines in the 980-1080 cm⁻¹ region including the Q branch feature at ˜1033 cm⁻¹ for the C—O stretching band. When commercial Zr(OH)₄ is exposed to DMMP vapor, methanol is quickly generated and continues growing over time (1 h in this case) (Balow). Methanol is also generated from the most active aerogel (ZrOₓH_{y}—350° C.), but at more modest rates and concentrations, suggesting that the aerogel surface retains more methoxy groups compared to Zr(OH)₄. Although less toxic than the incoming CWA, evolved methanol still represents a potential toxicity concern to the user, thus retention of such DMMP decomposition byproducts within the aerogel is preferred.

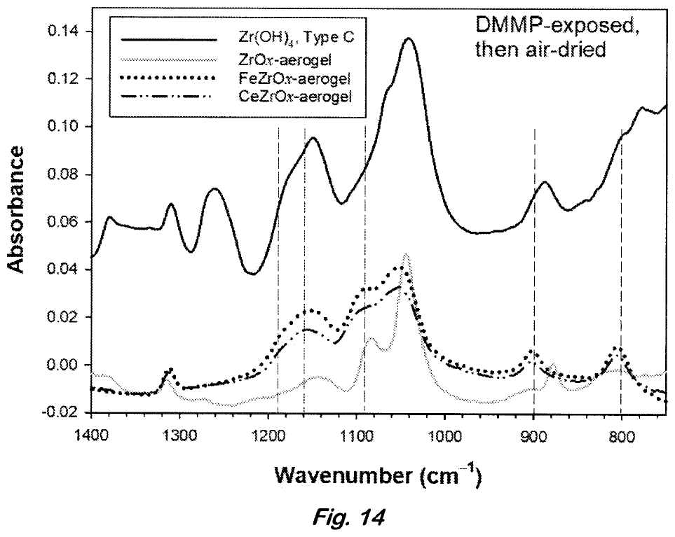

Zirconia aerogel variants were prepared where 5 atom % of the Zr⁴⁺ content was substituted for either Fe^{3 +} or Ce⁴⁺ in the initial sol-gel synthesis. The resulting Fe-ZrOₓH_{y} and Ce-ZrOₓH_{y} aerogels were thermally treated under similar conditions to that used for unsubstituted ZrOₓH_{y}. The presence of Fe^{3 +} or Ce⁴⁺ in the ZrOₓH_{y}aerogel may also promote the removal of organic byproducts (as evidenced by IR spectroscopy) such that 250° C. may be a sufficient calcination temperature to achieve an active substrate for DMMP decomposition. Preliminary IR characterization of a series of substituted ZrOₓH_{y} aerogels after exposure to vapor-phase DMMP, followed by outgassing of nonadsorbed/reacted vapor, is shown in FIG. 14.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A composition comprising:
a zirconium oxy(hydroxide) aerogel;
wherein the aerogel is doped with one or more of Fe³⁺ ions, Ce³⁺ ions, Fe²⁺ ions, Ce⁴⁺ ions, NO₃⁻ ions, Cl⁻ ions, CH₃CO₂⁻ ions, oxychlorides, and acetylacetonate ions.

2. The composition of claim 8, wherein the aerogel is doped with Fe³⁺ ions.

3. The composition of claim 8, wherein the aerogel is doped with Ce³⁺ ions.

4. A method comprising:
providing a solution comprising:
ZrCl₄;
a second solute selected from FeCl₃, CeCl₃, Fe³⁺ salts, Fe²⁺ salts, Ce³⁺ salts, Ce⁴⁺ salts, NO₃⁻ salts, Cl⁻ salts, CH₃CO₂⁻ salts, oxychlorides, and acetylacetonate salts; and
a solvent;
adding a cyclic ether to the solution to form a gel;
infiltrating the gel with liquid carbon dioxide;
applying a temperature and pressure to form supercritical fluid carbon dioxide; and
removing the carbon dioxide for form an aerogel.

5. The method of claim 11, wherein the second solute is FeCl₃.

6. The method of claim 11, wherein the second solute is CeCl₃. The method of claim 11, wherein the solvent is water or methanol.

8. The method of claim 11, wherein the cyclic ether is propylene oxide.

9. The method of claim 11, further comprising:
heating the aerogel to remove residual organic compounds.
